(19) United States
(12) Patent Application Publication
(10) Pub. No.: US 2013/0097088 A1
(43) Pub. Date: Apr. 18, 2013

(54) WARRANTY EXPIRATION DATE DETERMINING DEVICE AND WARRANTY EXPIRATION DATE DETERMINING METHOD

(71) Applicants: Hideo Umetani, Osaka (JP); Masaru Yamaoka, Osaka (JP); Fumiaki Suzuki, Osaka (JP); Mariko Nakaso, Shiga (JP)

(72) Inventors: Hideo Umetani, Osaka (JP); Masaru Yamaoka, Osaka (JP); Fumiaki Suzuki, Osaka (JP); Mariko Nakaso, Shiga (JP)

(73) Assignee: PANASONIC CORPORATION, Kadoma-shi, Osaka (JP)

(21) Appl. No.: 13/805,015

(22) PCT Filed: Apr. 16, 2012
(86) PCT No.: PCT/JP2012/002620

§ 371 Date: Dec. 18, 2012

(30) Foreign Application Priority Data
Apr. 21, 2011 (JP) 2011-095537

(51) Int. Cl. G06Q 30/00

(52) U.S. Cl. CPC G06Q 30/012
USPC 705/302

(57) ABSTRACT

A warranty expiration date determining device includes: a receiving unit which receives owner information, appliance information, and operating information of a device; an obtaining unit which obtains, from an information database in which at least owner information, appliance information, and operating information of appliances are registered in association with respective owners of the appliances, operating information associated with a specific owner inferred among the owners of the appliances, based on the owner information and the appliance information of the device received, a usage period estimating unit which estimates a usage period of the appliance based on the obtained operating information and the received operating information; and a warranty expiration date determining unit which determines a first day of use of the appliance by extending back the estimated usage period from current time and date, and determines the warranty expiration date of the appliance.

### TECHNICAL FIELD

The present disclosure relates to warranty expiration date determining devices and warranty expiration date determining methods which determine expiration date of warranties of appliances.

### BACKGROUND ART

In recent years, appliance manufacturers have been studying systems for collecting, on their own servers or the like, information of appliances after sales via networks. Examples of the appliance information to be collected here include item numbers and operating histories of appliances. Appliance manufacturers can perform customer relationship management (CRM) by using collected appliance information for after-sales customer management or appliance management.

Examples of after-sales customer management or appliance management include management of warranty periods of appliances. In the case of the management of warranty periods of appliances, servers or the like of the appliance manufacturers manage warranty periods of appliances after being purchased. Hence, when appliance malfunction occurs after purchase, users may determine if the appliances are under warranty by checking with servers of the appliance manufacturers which manage warranty periods, even in a case where warranty certificates are missing. In this way, appliance manufacturers may perform CRM.

For example, Patent Literature (PTL) 1 discloses a method for determining a warranty starting date of an appliance. In the method, a manufacturer inputs appliance delivery date in a management system of the manufacturer, and a purchaser inputs order date in a purchaser system. In the method disclosed in PTL 1, the delivery date input into the management system by the manufacturer and the order date input by the user are compared. When the difference between the delivery date and the order date does not exceed predetermined time length or days, the order date input by the user is determined to be the warranty starting date, thereby determining the warranty period of the appliance.

### CITATION LIST

### Patent Literature

Japanese Unexamined Patent Application Publication No. 2002-312570

### SUMMARY OF INVENTION

### Technical Problem

However, the conventional technique as disclosed in PTL1 above cannot automatically determine the warranty starting dates of appliances after being purchased.

The present disclosure has been conceived to solve such a problem, and has an object to provide a warranty expiration date determining device, a warranty expiration date determining method, and the like which can determine the warranty starting dates of appliances.

### Solution To Problem

In order to achieve the object, a warranty expiration date determining device according to one aspect of the present disclosure includes: a receiving unit which receives first owner information, first appliance information, and first operating information of a first appliance for which a warranty expiration date is to be calculated; an obtaining unit which obtains, from an information database in which at least second owner information, second appliance information, and second operating information of a plurality of second appliances are registered in association with respective owners of the second appliances, the second operating information associated with a specific owner inferred among the owners of the second appliances, based on the first owner information and the first appliance information received by the receiving unit, the second appliances being different from the first appliance; a usage period estimating unit which estimates a usage period of the first appliance based on the second operating information obtained by the obtaining unit and the first operating information received by the receiving unit; a time information obtaining unit which obtains information on current time and date; and a warranty expiration date determining unit which (i) determines a first day of use of the first appliance by extending back the usage period estimated by the usage period estimating unit from the obtained current time and date, and (ii) and determines the warranty expiration date of the first appliance.

These general and specific aspects may be implemented not only as a device, but also as a method including, as steps, processing units included in the device (a program causing a computer to execute such steps), a system, and any combination of systems and methods.

### Advantageous Effects of Invention

According to the present disclosure, it is possible to achieve a warranty expiration date determining device and the like which can determine the warranty starting dates of appliances.

### BRIEF DESCRIPTION OF DRAWINGS

FIG. 1A shows an example of a configuration of a warranty expiration date system according to Embodiment 1.

FIG. 1B shows another example of a configuration of the warranty expiration date system according to Embodiment 1.

FIG. 2 is a functional block diagram showing an example of a structure of a warranty expiration date determining device according to Embodiment 1.

FIG. 3 schematically shows appliances registered in information database of the warranty expiration date determining device according to Embodiment 1.

FIG. 4 shows an example of a structure of the information database shown in FIG. 2.

FIG. 5A is a functional block diagram showing an example of a structure of an appliance according to Embodiment 1.

FIG. 5B is a functional block diagram showing another example of the appliance according to Embodiment 1.

FIG. 6 is a sequence diagram of operations of the warranty expiration date determining device and the appliance according to Embodiment 1.

FIG. 7 is a functional block diagram showing an example of a structure of a warranty expiration date determining device according to Variation of Embodiment 1.

FIG. 8 is a sequence diagram of operations of the warranty expiration date determining device, an appliance, and information database according to Variation of Embodiment 1.

FIG. 9 shows an example of a configuration of a warranty expiration date system according to Embodiment 2.

FIG. 10 is a functional block diagram showing an example of a structure of a warranty expiration date determining device according to Embodiment 2.

FIG. 11 is a sequence diagram of operations of the warranty expiration date determining device, an appliance, and a display terminal according to Embodiment 2.

### DESCRIPTION OF EMBODIMENTS

### Background To Embodiments of the Present Disclosure

Hereinafter, a description is given of background to Embodiments of the present disclosure.

In the technique disclosed in PTL 1, manufacturers, dealers, and users need to manually input information such as delivery dates and order dates to determine the warranty starting dates of appliances.

A possible method for eliminating necessity for manual input is a method in which starting dates of warranty periods are automatically determined assuming the dates on which appliances are registered in systems as the warranty starting dates. However, for example, in a case where an appliance is registered in a system after being used for a predetermined period from the purchase date, the registered date becomes the starting date of warranty period even though the appliance has been used. As a result, this method cannot properly set warranty periods.

Another possible method is a method in which the starting date of warranty period is determined by storing the date on which a user first used an appliance in an internal memory or the like of the appliance as the first day of use, and the stored first day of use is transmitted to a server at the time of registration of the appliance. However, since an appliance determines the first day of use in this method, a unit, such as a clock, is necessary for determining the first day of use. Furthermore, including a clock in an appliance requires a battery for driving the clock, thereby increasing manufacturing cost of the appliance. Thus, only some appliances which require clock data, such as DVD recorders and rice cookers, actually include clocks. As a result, only some appliances can use this method for determining the warranty starting date, and other appliances which do not include clocks cannot determine the warranty starting date.

An aspect of the present disclosure has been conceived to solve such problems, and has an object to provide a warranty expiration date determining device, a warranty expiration date determining method, and the like which can determine the warranty starting date of an appliance even without including a clock.

In order to achieve the object, a warranty expiration date determining device according to one aspect of the present disclosure includes: a receiving unit which receives first owner information, first appliance information, and first operating information of a first appliance for which a warranty expiration date is to be calculated; an obtaining unit which obtains, from an information database in which at least second owner information, second appliance information, and second operating information of a plurality of second appliances are registered in association with respective owners of the second appliances, the second operating information associated with a specific owner inferred among the owners of the second appliances, based on the first owner information and the first appliance information received by the receiving unit, the second appliances being different from the first appliance; a usage period estimating unit which estimates a usage period of the first appliance based on the second operating information obtained by the obtaining unit and the first operating information received by the receiving unit; a time information obtaining unit which obtains information on current time and date; and a warranty expiration date determining unit which (i) determines a first day of use of the first appliance by extending back the usage period estimated by the usage period estimating unit from the obtained current time and date, and (ii) and determines the warranty expiration date of the first appliance.

According to this aspect, it is possible to achieve a warranty expiration date determining device which can determine the warranty starting date of an appliance.

More specifically, according to the warranty expiration date determining device, it is possible to estimate the first day of use of a first appliance for which the warranty expiration date is to be calculated, using first operating information of the first appliance and second operating information of a specific owner (a specific user) already registered in information database.

Here, for example, the first operating information may include usage frequency of the first appliance and an average usage length which is an average length of usage of the first appliance per day.

Thus, the first appliance, for which the warranty expiration date is to be calculated, may include, for example, a counter instead of a clock. The first appliance only requires measuring usage length or usage count of the first appliance, and accumulates the total usage length or total usage count of the first appliance.

More specifically, the total usage length or the total usage count of the first appliance measured by the counter is not sufficient for the warranty expiration date determining device to accurately determine the warranty starting date. However, by collecting the total usage length or the like of the first appliance as the first operating information of an owner (a user), it is possible to estimate the first day of use of the first appliance, based on the collected first operating information and second operating information of a specific owner (a specific user) already registered in information database.

In this way, even in a case where the first appliance does not include a clock function, it is possible for the warranty expiration date determining device to determine the warranty starting date of the first appliance by estimating the first day of use based on second operating history of the specific owner (specific user) or the same owner (same user) similar to first operating history of the first appliance. As a result, the warranty expiration date determining device can determine the warranty expiration date without requiring users to input the first day of use of the first appliance, making it easy for the users.

Furthermore, for example, it may be that the warranty expiration date determining device further includes a determining unit which determines whether or not the usage period estimated by the usage period estimating unit exceeds a threshold which indicates that the usage period estimated by the usage period estimating unit falls within a usage period usable by the warranty expiration date determining unit for determining the first day of use, and that the warranty expiration date determining unit determines the first day of use based on a result of the determination by the determining unit.

Here, for example, it may be that the warranty expiration date determining device further includes a transmitting unit which transmits, to an owner of the first appliance, a notification prompting the owner of the first appliance to input a first day of use usable by the warranty expiration date determining unit for determining the first day of use, and that when the determining unit determines that the usage period estimated by the usage period estimating unit exceeds the threshold, the determining unit causes the transmitting unit to transmit the notification, the receiving unit receives information on the first day of use which is input by the owner of the first appliance and which is usable by the warranty expiration date determining unit for determining the first day of use, and the warranty expiration date determining unit determines, as a warranty starting date, the first day of use included in the information input by the owner of the first appliance.

With this, the warranty expiration date determining device can properly set the warranty expiration date even when the estimated first day of use is before the date on which the owner (user) actually started to use the first appliance.

Furthermore, for example, it may be that when the determining unit determines that the usage period estimated by the usage period estimating unit does not exceed the threshold, the warranty expiration date determining unit determines, as a warranty starting date, a registration date of the first appliance on which the owner of the first appliance registered the first owner information and the first appliance information into the information database.

Furthermore, for example, it may be that the obtaining unit infers, from among the information database, an owner of the second appliance as the specific owner using the first owner information and the first appliance information received by the receiving unit, the owner of the second appliance associated with the second owner information and the second appliance information that are similar to the first owner information and the first appliance information; and obtains the second operating information associated with the inferred specific owner.

Furthermore, for example, it may be that the obtaining unit infers, from among the information database, an owner of the second appliance as the specific owner using the first owner information and the first appliance information received by the receiving unit, the owner of the second appliance associated with the same owner information as the first owner information and associated with the second appliance information similar to the first appliance information; and obtains the second operating information associated with the inferred specific owner.

Here, for example, it may be that the first owner information includes at least one of a name, an age, a sex, a family structure, and an occupation of the owner of the first appliance, and the second owner information includes at least one of a name, an age, a sex, a family structure, and an occupation of the owner of the second appliance, and the first appliance information indicates a type of the first appliance, and the second appliance information indicates a type of the second appliance.

Here, for example, it may be that the warranty expiration date determining unit registers the determined warranty expiration date of the first appliance into the information database, in association with the first owner information and the first appliance information.

Here, for example, it may be that the warranty expiration date determining device includes the information database.

Furthermore, in order to solve the problems, a warranty expiration date determining method according to one aspect of the present disclosure is a warranty expiration date determining method for use in a warranty expiration date determining device which determines a warranty expiration date of a first appliance. The warranty expiration date determining method includes: receiving first owner information, first appliance information, and first operating information of the first appliance; obtaining, from an information database in which at least second owner information, second appliance information, and second operating information of a plurality of second appliances are registered in association with respective owners of the second appliances, the second operating information associated with a specific owner inferred among the owners of the second appliances, based on the first owner information and the first appliance information received in the receiving; estimating a usage period of the first appliance based on the first operating information received in the receiving and the second operating information obtained in the obtaining of the second operating information; obtaining information on current time and date; and determining a first day of use of the first appliance by extending back the usage period estimated in the estimating from the obtained current time and date, and determining the warranty expiration date of the first appliance.

Furthermore, in order to solve the problems, a program for determining a warranty expiration date of a first appliance according to one aspect of the present disclosure is a program for determining a warranty expiration date of a first appliance. The program causes a computer to execute: receiving first owner information, first appliance information, and first operating information of the first appliance; obtaining, from an information database in which at least second owner information, second appliance information, and second operating information of a plurality of second appliances are registered in association with respective owners of the second appliances, the second operating information associated with a specific owner inferred among the owners of the second appliances, based on the first owner information and the first appliance information received in the receiving; estimating a usage period of the first appliance based on the first operating information received in the receiving and the second operating information obtained in the obtaining of the second operating information; obtaining information on current time and date; and determining a first day of use of the first appliance by extending back the usage period estimated in the estimating from the obtained current time and date, and determining the warranty expiration date of the first appliance.

Furthermore, in order to solve the problems, a system according to one aspect of the present disclosure is a warranty expiration date determining system which includes: a first appliance for which a warranty expiration date is to be calculated; and a warranty expiration date determining device which calculates the warranty expiration date of the first appliance. The first appliance includes: an input unit which receives an operation of a user; a counter which measures a usage length or a usage count of the first appliance; a control unit which activates the first appliance and the counter based on the operation received by the input unit; an accumulating unit which accumulates the value measured by the counter; an appliance information managing unit which manages appliance information of the first appliance; and a transmitting unit which transmits the value of the counter accumulated in the accumulating unit to the warranty expiration date determining device as operating information of the first appliance, along with at least the first appliance information. The warranty expiration date determining device includes: a receiving unit which receives first owner information, the first appliance information, and the first operating information of the first appliance; an obtaining unit which obtains, from an information database in which at least second owner information, second appliance information, and second operating information of a plurality of second appliances are registered in association with respective owners of the second appliances, the second operating information associated with a specific owner inferred among the owners of the second appliances, based on the first owner information and the first appliance information received by the receiving unit, the second appliances being different from the first appliance; a usage period estimating unit which estimates a usage period of the first appliance based on the second operating information obtained by the obtaining unit and the first operating information received by the receiving unit; a time information obtaining unit which obtains information on current time and date; and a warranty expiration date determining unit which (i) determines a first day of use of the first appliance by extending back the usage period estimated by the usage period estimating unit from the obtained current time and date, and (ii) and determines the warranty expiration date of the first appliance.

Here, an appliance according to one aspect of the present disclosure is an appliance for which a warranty expiration date is to be calculated. The appliance includes: an input unit which receives an operation of a user; a counter which measures a usage length or a usage count of the appliance; a control unit which activates the appliance and the counter based on the operation received by the input unit; an accumulating unit which accumulates a value measured by the counter; an appliance information managing unit which manages appliance information of the appliance; and a transmitting unit which transmits the value of the counter accumulated in the accumulating unit to a warranty expiration date determining device as operating information of the appliance, along with the appliance information, the warranty expiration date determining device calculating the warranty expiration date of the appliance.

Furthermore, for example, it may be that the appliance includes an operating history generating unit configured to generate a total usage length or a total usage count based on the value measured by the counter, and that the transmitting unit transmits the total usage length or the total usage count generated by the operating history generating unit to the warranty expiration date determining device as the operating information of the appliance, along with the appliance information.

Furthermore, it may be that the transmitting unit transmits the value accumulated in the accumulating unit to a relay device to cause the relay device (i) to generate a total usage length or a total usage count based on the value measured by the counter, and (ii) to transmit the generated total usage length or the total usage count to the warranty expiration date determining device as the operating information of the appliance, along with the first owner information and the appliance information of the appliance, the relay device holding at least the owner information and the appliance information of the appliance and being capable of transmitting data to the warranty expiration date determining device.

Each of the exemplary embodiments described below shows a general or specific example. The numerical values, structural elements, the arrangement and connection of the structural elements, steps, the processing order of the steps etc. shown in the following exemplary embodiments are mere examples, and therefore do not limit the scope of the appended Claims and their equivalents. Among the structural elements in the following exemplary embodiments, structural elements not recited in any one of the independent claims are described as arbitrary structural elements.

Hereinafter, a description is given of a warranty expiration date determining device and a warranty expiration date determining method according to Embodiments of the present disclosure, referring to the drawings. In the following description, the same structural elements are assigned with the same referential numerals. They have the same name and functions. Accordingly, detailed descriptions thereof may be omitted.

### Embodiment 1

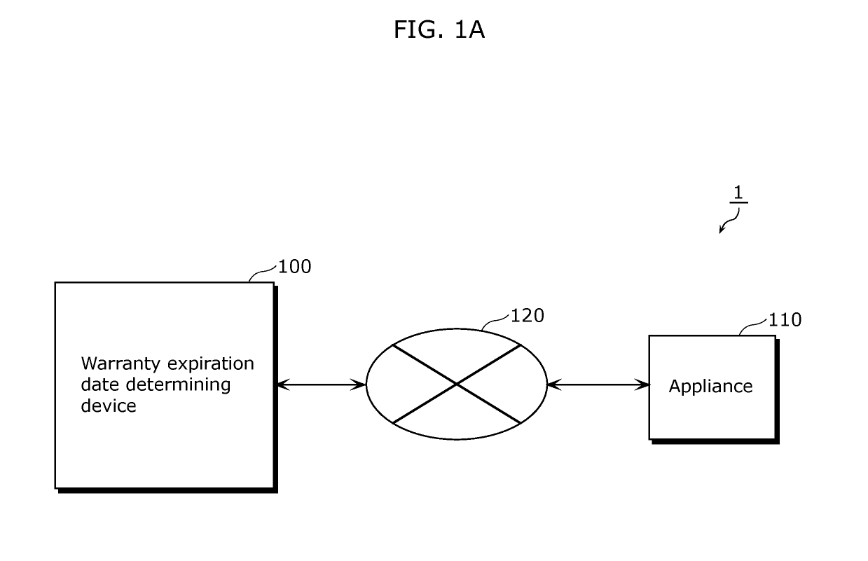

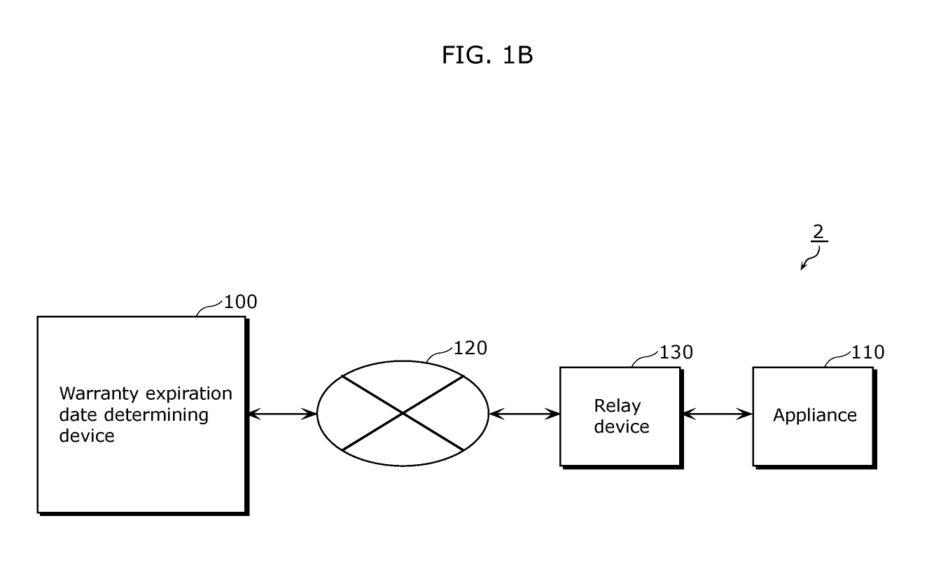

FIG. 1A shows an example of a configuration of a warranty expiration date system 1 according to Embodiment 1. In FIG. 1A, the warranty expiration date system 1 according to Embodiment 1 includes a warranty expiration date determining device 100 and an appliance 110. The warranty expiration date determining device 100 is connected to the appliance 110 via a network 120.

The warranty expiration date determining device 100 determines the warranty expiration date of the appliance 110 connected via the network 120. The warranty expiration date determining device 100 is provided, for example, in a server or the like managed by an appliance manufacturer.

The appliance 110 is an appliance having a warranty starting date and a warranty expiration date which have not yet been registered in information database 206 that will be described later. Here, the appliance 110 does not generally include a clock. Examples of the appliance 110 include a washing machine, a microwave, an air conditioner, and a dish washer. The clock here is defined to include a function of calculating date and time, in addition to a function of measuring time.

Examples of the network 120 include a wired network such as Ethernet (registered trademark), a wireless network such as a wireless LAN, a public network, and a network including a combination thereof. The public network refers to communication lines provided by telecommunications carriers for general public communication. Examples of the public network include ordinary phone line and ISDN.

FIG. 1B shows another example of a configuration of the warranty expiration date system according to Embodiment 1. As shown in a warranty expiration date system 2 of FIG. 1B, the warranty expiration date determining device 100 may be connected to a relay device 130 via the network 120. In such a case, the warranty expiration date determining device 100 is always connected or suitably connected with the appliance 110 via the relay device 130. Here, the relay device 130 is an example of a relay device such as a router, and is at least capable of holding owner information of the appliance 110, and transmitting data to the warranty expiration date determining device 100.

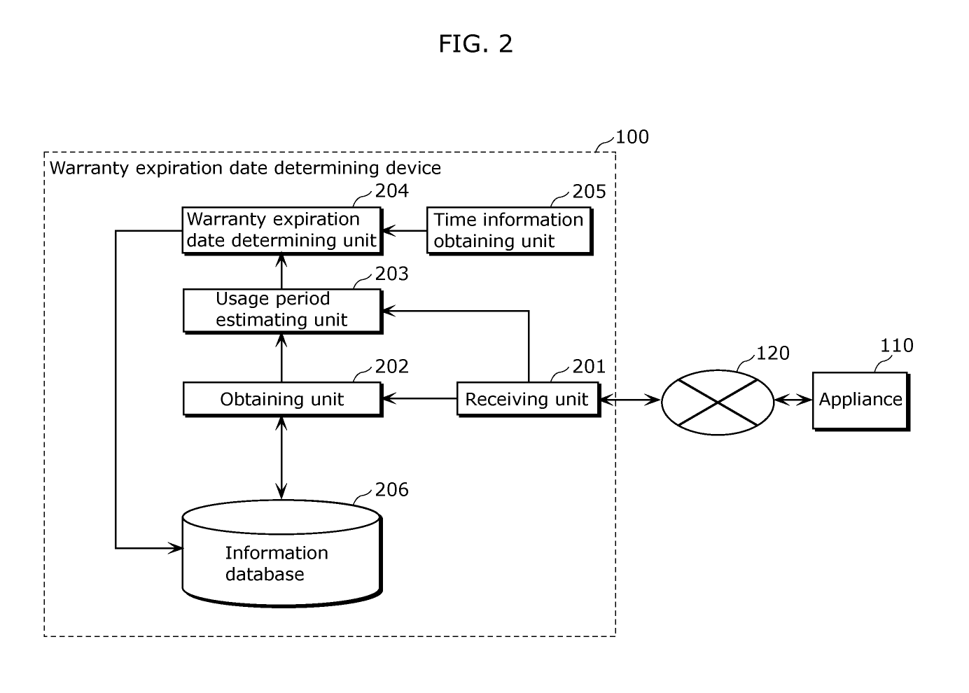

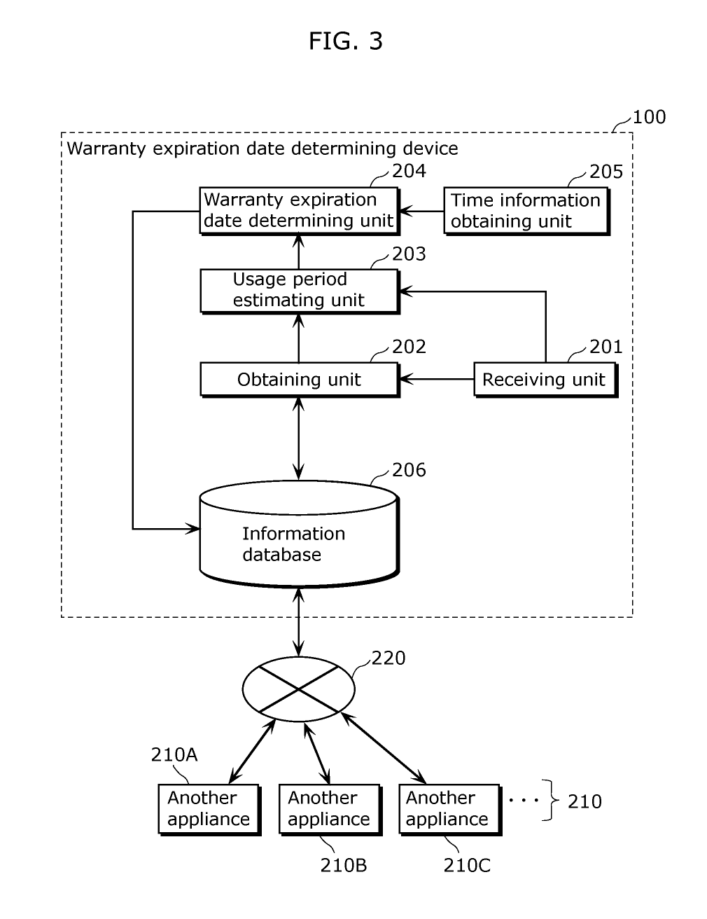

FIG. 2 is a functional block diagram of the warranty expiration date determining device 100 according to Embodiment 1. For explanation purposes, the network 120 and the appliance 110 are also shown in FIG. 2. FIG. 3 schematically shows appliances 210 registered in information database 206 of the warranty expiration date determining device 100 according to Embodiment 1.

As shown in FIG. 2, the warranty expiration date determining device 100 according to Embodiment 1 includes: a receiving unit 201; an obtaining unit 202; a usage period estimating unit 203; a warranty expiration date determining unit 204; a time information obtaining unit 205; and the information database 206.

The receiving unit 201 receives owner information, appliance information and operating information of the appliance 110 for which the warranty expiration date is to be calculated. More specifically, the receiving unit 201 receives owner information of a user of the appliance 110, and the appliance information and operating information of the appliance 110 which are not registered in the information database 206.

Examples of the owner information here includes a combination of any of owner's name, sex, birthday, address, family structure, telephone number, email address, occupation, and housing, and an owner ID associated with the aforementioned information. Examples of the appliance information include a type of appliance, an item number of appliance, and an appliance ID. Examples of the operating information of appliance include the usage length of appliance and usage count of the appliance. Furthermore, the operating information of the appliance may be usage frequency of an appliance or an average usage length which is an average length of usage of an appliance in a day. Detailed description thereof will be given later.

The obtaining unit 202 obtains operating information associated with a specific owner (a specific user) inferred among the owners of appliances 210 (for example, 210A, 210B, and 210C) which are different from the appliance 110, based on the owner information and appliance information of the appliance 110 received by the receiving unit 201, from the information database 206 in which at least owner information, appliance information, and operating information of the appliances 210 are registered in associated with respective owners of the appliances 210. Here, for example, the receiving unit 202 infers, using the owner information and appliance information of the appliance 110 received by the receiving unit 201, the owner of the appliance 210 associated with the owner information and the appliance information similar to the owner information and the appliance information of the appliance 110, as a specific user (a specific owner) from the database 206, and obtains the operating information of the appliance 210 associated with the inferred specific user. Furthermore, for example, the obtaining unit 202 infers, using the owner information and the appliance information of the appliance 110 received by the receiving unit 201, the owner of the appliance 210 associated with the same owner information as the owner information of the appliance 110 and associated with the appliance information of the appliance 210 similar to the appliance information of the appliance 110, as a specific user from the information database 206, and obtains the operating information of the appliance 210 associated with the inferred specific user.

More specifically, the obtaining unit 202 obtains, from the information database 206, operating information of the user similar to or same as the owner information and the appliance information received by the receiving unit 201. Here, the term “similar users” refers to users who have, for example, a similar family structure, sex, age, and occupation. Furthermore, the term “similar appliances” refers to the same type of appliances, such as washing machines.

Examples of a method performed by the obtaining unit 202 for extracting a specific user include a method in which clustering is used. More specifically, for example, a hierarchical method (Ward method) or a non-hierarchical method (K-means method) may be used.

The usage period estimating unit 203 estimates the usage period of the appliance 110 from the operating information associated with the specific user obtained by the obtaining unit 202 and the operating information of the appliance 110 received by the receiving unit 201. More specifically, the usage period estimating unit 203 estimates the usage period of the appliance 110, based on the operating information received by the receiving unit 201 and the operating information obtained by the obtaining unit 202. In other words, the usage period estimating unit 203 estimates the usage period of the appliance 110 from the operating information of the appliance 110, and the operating information of the past similar appliances of the user similar to or the same as the operating information of the appliance 110.

The usage period of the appliance 110 is estimated, for example, by the following methods.

### Estimation Method 1

When T represents total usage length, X represents usage frequency (times/day), and Y represents usage length (hours/time), the usage period is defined by [T/(X×Y)]. Here, [ ] represents Gauss symbol (floor and ceiling functions).

### Estimation Method 2

When S represents total usage count, and X represents usage frequency (times/day), the usage period is defined by [S/X]. Here, [ ] represents Gauss symbol.

Here, for example, the total usage length T and the total usage count S are obtained from the operating information of the appliance 110 received by the receiving unit 201. Furthermore, the usage frequency X and the usage length Y are obtained from, for example, the operating information associated with the user similar to or the same as the owner information and the appliance information of the appliance 110 registered in the information database 206.

Furthermore, for example, in the case of estimating the usage period by the estimation method 1, the usage period estimating unit 203 estimates that the usage period is [30/(2×0.5)]=30 days when the total usage length is 30 hours, the usage frequency is two times/day, and the usage length is 0.5 hour/time.

Furthermore, in the case of estimating the usage period by the estimating method 2, the usage period estimating unit 203 estimates that the usage period is [30/2]=15 days when the total usage count is two times/day.

The warranty expiration date determining unit 204 determines the first day of use of the appliance 110 by extending back the usage period estimated by the usage period estimating unit 203 from the obtained current time, and determines the warranty expiration date of the appliance 110. More specifically, the warranty expiration date determining unit 204 determines the first day of use of the appliance 110 from the usage period estimated by the usage period estimating unit 203 and the current time obtained by the time information obtaining unit 205, and determines the warranty expiration date of the appliance 110. The warranty expiration date determining unit 204 then stores the determined warranty expiration date in association with the appliance ID, in the “appliance information 302” of the information database 206.

The time information obtaining unit 205 obtains information on current time and date. More specifically, the time information obtaining unit 205 obtains current time and transmits the obtained current time to the warranty expiration date determining unit 204. The term “current time” refers to, for example, year, month, day, time, and day of the week. Here, the time information obtaining unit 205 may include a clock for detecting current time, or may obtain current time from an external device.

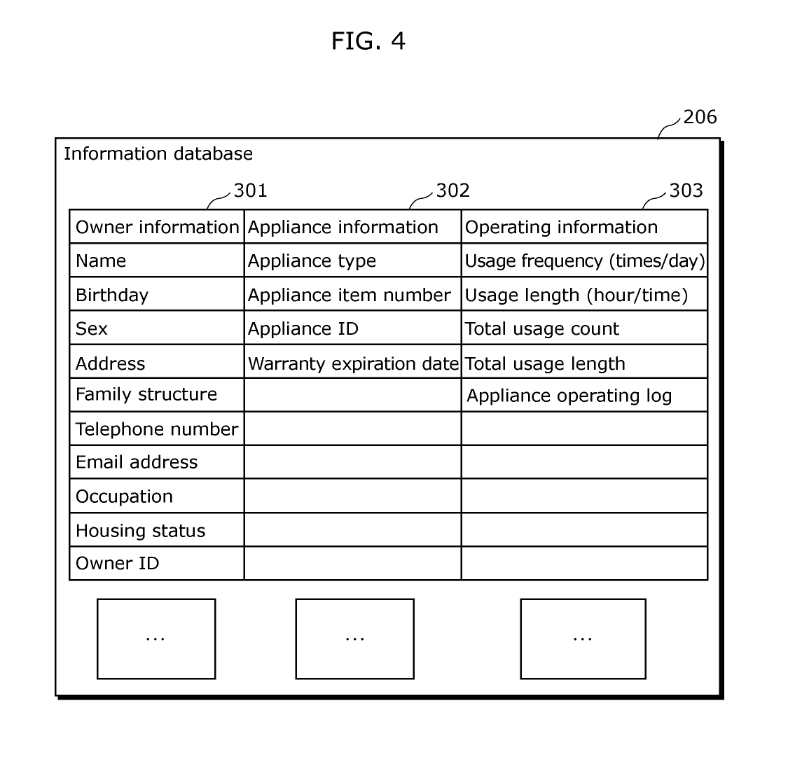

The information database 206 holds at least owner information, appliance information, and operating information of the appliances 210 (210A, 210B, 210C . . . ) different from the appliance 110, in association with respective owners of the appliances 110. More specifically, the information database 206 holds owner information of users of the appliance 110 and the appliances 210, appliance information of the appliances(the appliance 110, and the appliances 210), and operating information of the appliances (the appliance 110 and the appliances 210), in association with one another. Detailed descriptions of the information database 206 will be given later referring to FIG. 4; and thus, its description here is omitted.

In Embodiment 1, it is described that the information database 206 is included in the warranty expiration date determining device 100; however, the warranty expiration date determining device 100 does not always have to include the information database 206. As described in Variation below, the information database 206 may be provided outside the warranty expiration date determining device 100.

FIG. 4 shows an example of a structure of the information database 206 shown in FIG. 2 and FIG. 3. As described earlier, the information database 206 holds owner information 301, appliance information 302, and operating information 303 in association with one another.

Examples of the owner information 301 include owner's name, sex, birthday, address, family structure, telephone number, Email address, occupation, housing status, and owner ID.

Examples of the appliance information 302 include a type of appliance (the appliance 110 or the appliance 210) managed by users, an item number of the appliance, a uniquely assigned appliance ID, and warranty expiration date of the appliance.

Examples of the operating information 303 include usage frequency (times/day), usage length (hour/time), total usage length, total usage count, and appliance operating log of user. The appliance operating log of user may be on and off of appliance, or history of operations for causing the appliance to function.

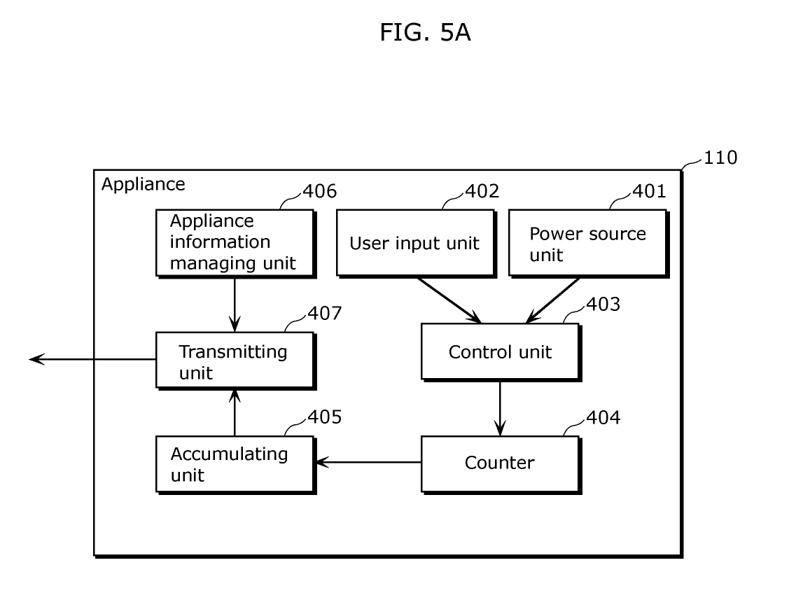

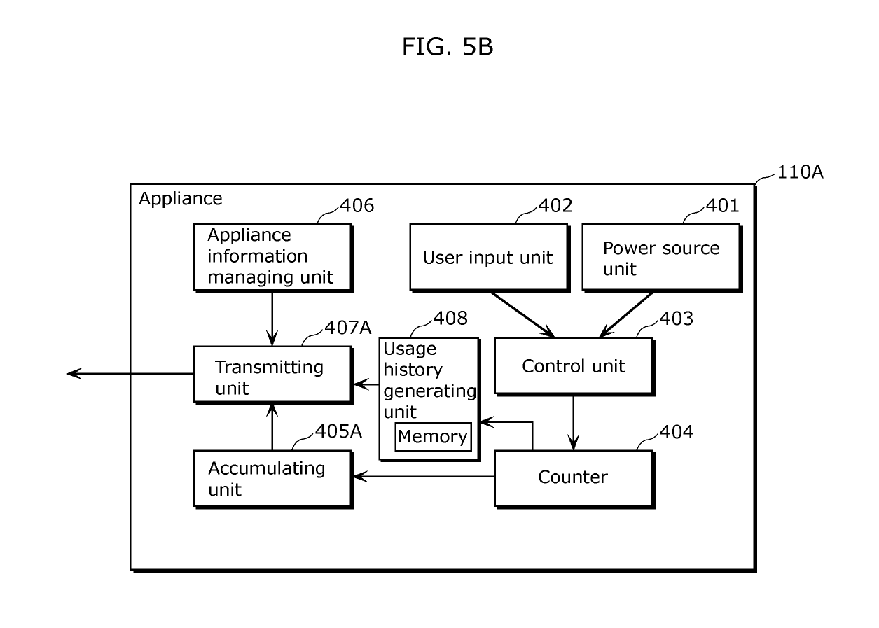

FIG. 5A is a functional block diagram of the appliance 110 according to Embodiment 1. The appliance 110 includes: a power source unit 401, a user input unit 402, a control unit 403, a counter 404, an accumulating unit 405, an appliance information managing unit 406, and a transmitting unit 407.

The power source unit 401 turns on and off the appliance 110, based on a command or an input from outside.

The user input unit 402 is an example of an input unit which receives user operation. Examples of the user input unit 402 include: a control panel operated by a user, such as a start button or a course selection button, and a receiving unit which receives user operation such as a light receiving unit which receives remote control or a communication unit such as a non-contact IC.

The control unit 403 causes the appliance 110 and the counter 404 to operate, based on the operations received by the user input unit 402. More specifically, the control unit 403 causes the counter 404 to operate, by turning on and off the power source, or by the operation received by the user input unit 402.

The counter 404 measures the usage length or usage count of the appliance 110.

The accumulating unit 405 accumulates, for example, the values measured by the counter 404. More specifically, the accumulating unit 405 accumulates the sum of the usage length that is the value measured by the counter 404 and the past usage length accumulated in the accumulating unit 405, or the sum of the usage count that is the value measured by the counter 404 and the past usage count accumulated in the accumulating unit 405. More specifically, the accumulating unit 405 accumulates, as operating information, sum of the usage length or usage count each time the usage length or usage count is measured by the counter 404. It may be that the accumulating unit 405 only adds the values measured by the counter 404 for accumulation.

The appliance information managing unit 406 manages appliance information of the appliance 110. The appliance information managing unit 406 stores, for example, appliance information such as an appliance type, an appliance ID, or a product serial number.

The transmitting unit 407 transmits, to the warranty expiration date determining device 100, the value of the counter 404 accumulated in the accumulating unit 405 as operating information of the appliance 110, along with the appliance information of the appliance 110. More specifically, the transmitting unit 407 transmits, to the warranty expiration date determining device 100, the operating information accumulated in the accumulating unit 405 (the sum value of the counter 404, total usage length or total usage count) and the appliance information stored in the appliance information managing unit 406.

In a case where the accumulating unit 405 only adds the values measured by the counter 404 for accumulation, the appliance 110 may include a usage history generating unit 408 in addition to the accumulating unit 405, as shown in FIG. 5B. The following describes such a case.

FIG. 5B is a functional block diagram showing another example of the structure of the appliance according to Embodiment 1. The similar elements to those shown in FIG. 5A are assigned with the same referential numerals, and their detailed descriptions are omitted.

The accumulating unit 405A adds the values measured by the counter 404 and accumulates the values.

The usage history generating unit 408 is an example of an operation history generating unit, and generates the total usage length or the total usage count, based on the value measured by the counter 404. The usage history generating unit 408 includes, for example, a memory, and holds the generated total usage length or the total usage count.

The transmitting unit 407A transmits, to the warranty expiration date determining device 100, the total usage length or the total usage count generated by the usage history generating unit 408, as operating information of the appliance 110A along with the appliance information of the appliance 110A.

Furthermore, it may be that the appliance 110 do not directly transmit the operating information and the appliance information to the warranty expiration date determining device 100, but transmits such information to the warranty expiration date determining device 100 via an external device such as the relay device 130 as shown in FIG. 1B.

Here, the relay device 130 is a device which holds at least owner information and appliance information of the appliance 110, and is capable of transmitting data to the warranty expiration date determining device 100. Upon receipt of the value accumulated in the accumulating unit 405 from the appliance 110, the relay device 130 generates the total usage length or the total usage count based on the value, and transmits the generated total usage length or the total usage count as the operating information of the appliance 110 to the warranty expiration date determining device, along with the first owner information and the appliance information.

More specifically, the transmitting unit 407 transmits the value accumulated in the accumulating unit 405 to the relay device 130, to cause the relay device 130 to transmit the operating information, the owner information, and the appliance information of the appliance 110 to the warranty expiration date determining device.

Next, a description is given of operations of the warranty expiration date determining device 100 according to Embodiment 1.

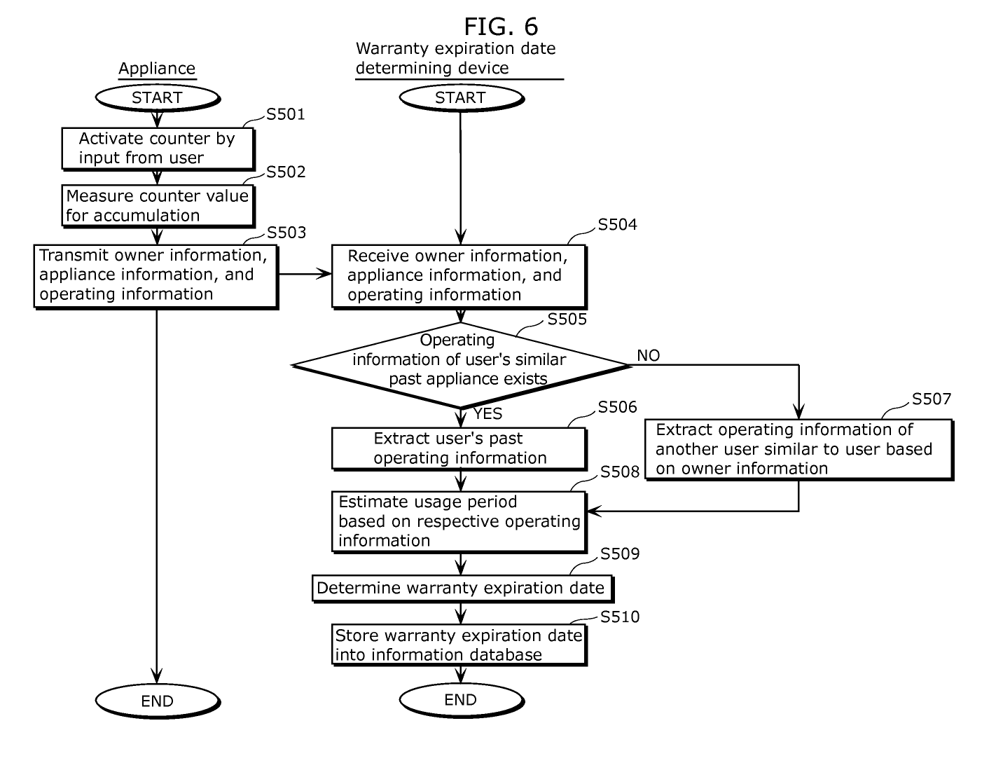

FIG. 6 is a sequence diagram of the operations of the warranty expiration date determining device 100 and the appliance 110 according to Embodiment 1.

First, a user turns on the power source unit 401 of the appliance 110, or operates the user input unit 402 of the appliance 110. Then, the appliance 110 activates the counter 404 (S501).

Next, the accumulating unit 405 adds the usage length or usage count measured by the counter 404 to the usage length or usage count accumulated in the accumulating unit 405, to update the usage length or the usage count (S502).

Next, the appliance 110 transmits the owner information and the appliance information of the appliance 110, and the operating information (total usage length or total usage count) of the appliance 110 accumulated in the accumulating unit 405 of the appliance 110, to the warranty expiration date determining device 100 (S503). Here, the owner information may be transmitted via a relay device or any other external devices.

Next, in the warranty expiration date determining device 100, the receiving unit 201 receives the owner information, the appliance information and the operating information of the appliance 110 (S504).

Next, the obtaining unit 202 determines whether or not the operating information of a similar appliance own by the user in the past (any one of the appliances 210) exists in the information database 206, based on the owner information of the user of the appliance 110 (S505).

When the operating information of the similar appliance owned by the user of the appliance 110 in the past exists in the information database 206, the obtaining unit 202 obtains the operating information of the similar past appliance from the information database 206 (S506).

On the other hand, when the operating information of the similar appliance owned by the user of the appliance 110 in the past does not exist in the information database 206, the obtaining unit 202 obtains, from the information database 206, the operating information of a similar appliance (any one of the appliances 210) of a user (a specific user) similar to the user of the appliance 110 (S507).

Next, the usage period estimating unit 203 estimates the usage period of the appliance 110, based on the obtained operating information of the specific user and the operating information of the appliance 110 (S508).

The warranty expiration date determining unit 204 calculates the first day of use of the appliance 110, based on the estimated usage period of the appliance 110 and the time information obtained by the time information obtaining unit 205, and determines the warranty expiration date (S509).

In S509, the warranty expiration date determining unit 204 can estimate the first day of use of the appliance 110 by extending back the warranty period from the time at which the usage period is estimated. Since the warranty period of the appliance 110 is already available, the warranty expiration date determining unit 204 can determine the warranty expiration date by adding the warranty period to the estimated first day of use.

Finally, the determined warranty expiration date is stored in the appliance information of the information database 206 in association with the appliance ID of the appliance 110 (S510).

As described, according to Embodiment 1, it is possible to achieve a warranty expiration date determining device which is capable of automatically determining the warranty starting date of appliances.

More specifically, the warranty expiration date determining device according to Embodiment 1 estimates the first day of use of the appliance 110 using the operating information such as the usage length or the usage count of the appliance 110 not yet registered in the information database 206 and the operating information of a specific user registered in the information database 206.

In the case of estimating the usage period of the appliance 110 without using history information of a specific user, a method may be used in which the total usage length of the appliance 110 is divided by 24 (hours). In this case, for example, in a case where the total usage length is 30 hours, it is estimated that the usage period is 30/24=1.25 day obtained by dividing 30 by 24.

However, for example, when the usage length of the appliance 110 per day is 3 hours in average and when the appliance 110 is used for 30 hours, it is estimated that the appliance 110 has been used for 10 days, which results in a large error between the estimated usage period and the actual usage period.

In contrast, the warranty expiration date determining device according to Embodiment 1 estimates the usage period of the appliance 110 using the operating information of a specific user similar to or the same as the appliance information of the appliance 110 among the operating information registered in the information database 206.

For example, in a case where the appliance 110 is an air conditioner, operating information of a specific user whose appliance type information indicates “air conditioner” is obtained from among the appliance information. Here, when the appliance 110 is an air conditioner, operating information of users related to air conditioners is extracted from among the operating information registered in the information database 206.

However, the user information related to air conditioners is not always similar to the user information of the appliance 110. More specifically, the usage length of air conditioners can vary depending on users, such as 3 hours, 5 hours or 7 hours per day. Thus, the warranty expiration date determining device according to Embodiment 1 obtains, from among the appliance information similar to or the same as the appliance 110, operating information of a specific user having owner information similar to or the same as the owner information of the appliance 110, and uses the obtained information.

More specifically, among the users of air conditioners, for example, operating information of a specific user who have similar birthday (age), sex, occupation, or family structure is obtained. In this way, the usage period of the appliance 110 is estimated using the operating information of the user similar to or same as the owner information. As a result, for example, the estimated usage period is likely to be closer to the actual usage period of the appliance 110 than the usage period estimated by averaging the usage length per day relative to air conditioners registered in the information database 206.

Accordingly, it is possible to increase the accuracy of estimation of the usage period of the appliance 110. Even when the appliance 110 does not include a clock function, it is possible to determine the warranty starting date of the appliance 110 more accurately than conventional methods.

It has been described above that among the appliance information similar to or same as the appliance 110, a user having owner information similar to or same as the owner information of the appliance 110 is identified; however, the present disclosure is not limited to this. For example, a specific user may be a group selected from groups into which users (owner information) of the appliances 210 registered in the information database 206 are classified based on predetermined criteria or the like, and operating information, including typical usage frequency, usage length or the like, may be held in the information database 206 for each group. In such a case, instead of a specific user, a specific group classified with the owner information similar to or same as the owner information of the appliance 110 is inferred, and the operating information of the inferred specific group is obtained.

### Variation

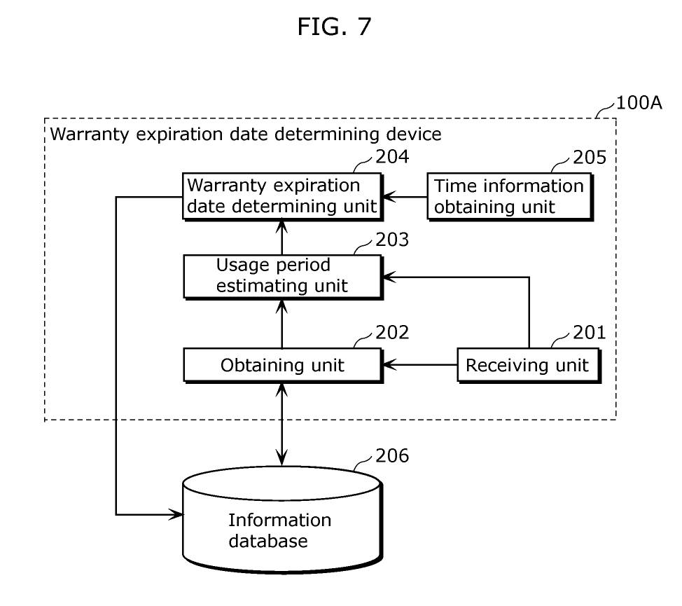

FIG. 7 is a functional block diagram showing an example of a structure of a warranty expiration date determining device according to Variation of Embodiment 1.

It has been described in Embodiment 1 that the information database 206 is included in the warranty expiration date determining device 100, but the present disclosure is not limited to such a structure. As shown in FIG. 7, the information database 206 may be provided externally to a warranty expiration date determining device 100A.

The following describes operations in this case.

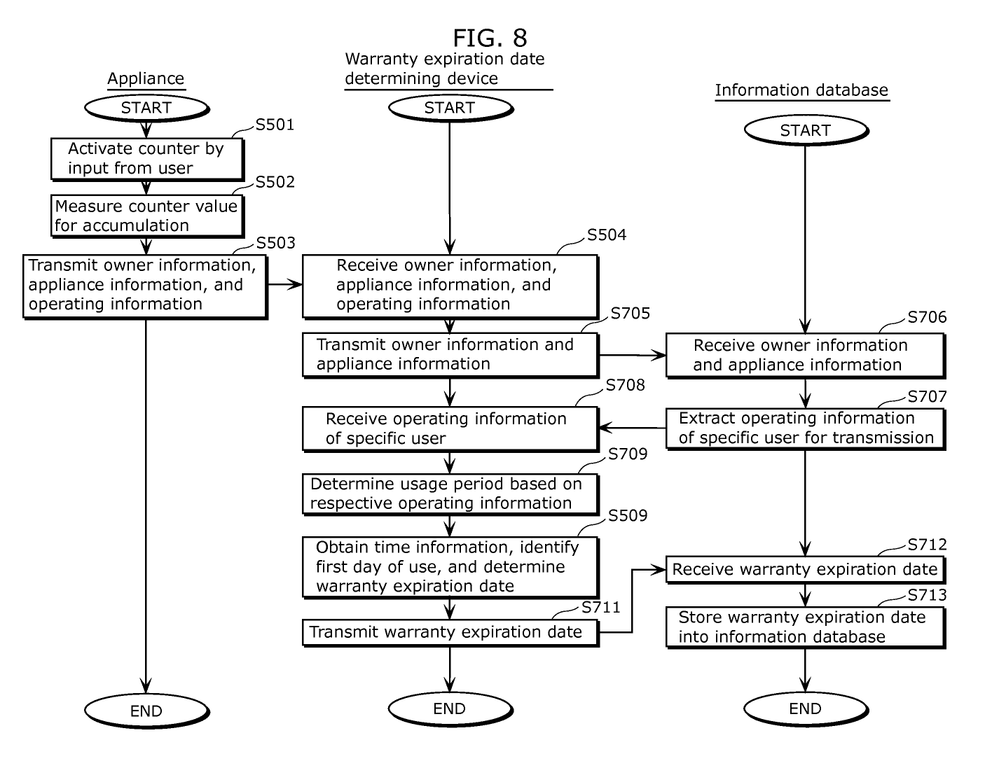

FIG. 8 is a sequence diagram of operations of the warranty expiration date determining device 100A, an appliance 110, and the information database 206 according to Variation of Embodiment 1. In FIG. 8, the same processing are performed for the steps having the numbers same as the step numbers shown in FIG. 6; and thus, duplicated descriptions are not given.

As shown in FIG. 8, upon receipt of owner information, appliance information, and operating information from the appliance 110 (S504), the warranty expiration date determining device 100A transmits the received owner information and appliance information to the information database 206 (S705).

Next, the information database 206 receives the owner information and the appliance information (S706), and extracts history information of a specific user by checking the received owner information and appliance information, and transmits the extracted history information of the specific user to the warranty expiration date determining device 100A (S707).

Next, the warranty expiration date determining device 100A receives the history of the specific user (S708).

Next, the usage period estimating unit 203 estimates the usage period of the appliance 110, using the received operating information of the specific user and the operating information of the appliance 110 (S709).

Processing in S509 is performed in the similar manner to Embodiment 1, thereby determining the warranty expiration date.

The warranty expiration date determining unit 204 transmits the determined warranty expiration date to the information database 206 (S711). The information database 206 receives the warranty expiration date (S712), and stores the received warranty expiration date into the appliance information in association with the appliance ID of the appliance 110 (S713).

### Embodiment 2

In Embodiment 1, a description has been given of a case where the warranty expiration date determining device directly determines the warranty expiration date from the estimated usage period. In Embodiment 2, a description is given of a case where the warranty expiration date determining device further determines whether or not the estimated usage period exceeds a predetermined threshold, and determines the warranty expiration date, based on the determination result.

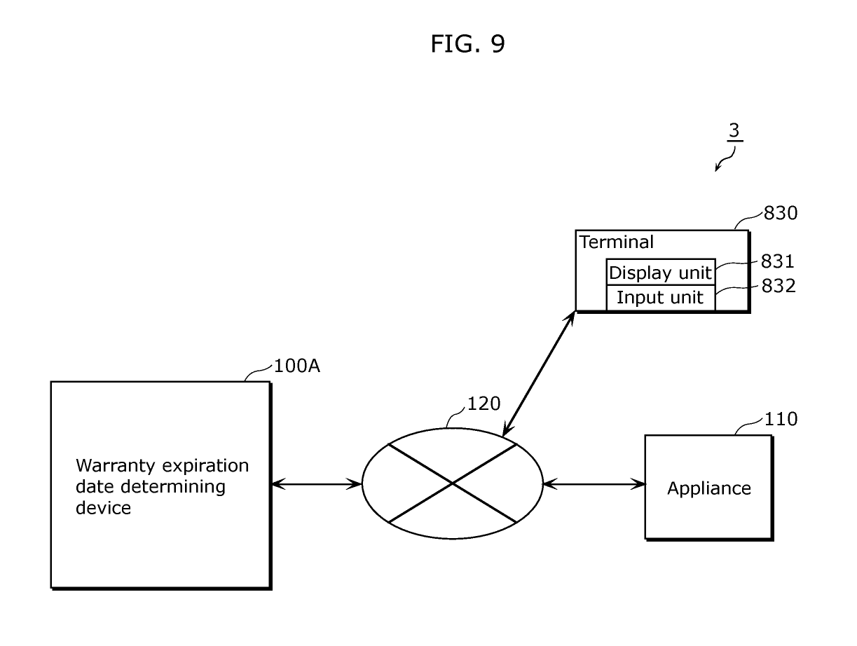

FIG. 9 shows an example of a configuration of a warranty expiration date system 3 according to Embodiment 2. In FIG. 9, the warranty expiration date system 3 according to Embodiment 2 includes a warranty expiration date determining device 100A, an appliance 110, and a terminal 830.

The warranty expiration date determining device 100A is connected to the appliance 110 and the terminal 830 via, for example, a network 120, as shown in FIG. 9.

Examples of the terminal 830 include a mobile phone, a smart phone, a personal computer, and a display panel. The terminal 830 includes a display unit 831 and an input unit 832.

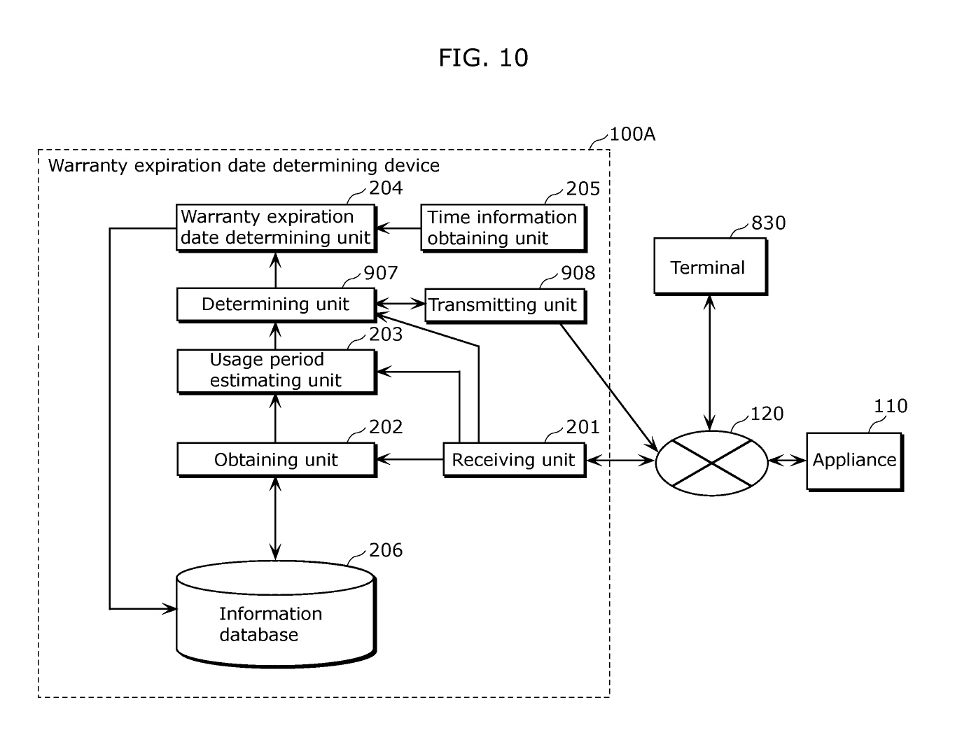

FIG. 10 is a functional block diagram of the warranty expiration date determining device 100A according to Embodiment 2. For explanation purposes, the appliance 110, the network 120 and the terminal 830 are also shown in FIG. 10.

As shown in FIG. 10, the warranty expiration date determining device 100A according to Embodiment 2 is different from the warranty expiration date determining device 100 in FIG. 2 in that a determining unit 907 and a transmitting unit 908 are further included. The other elements included in the warranty expiration date determining device 100A are similar to the elements included in the warranty expiration date determining device 100; and thus, duplicated descriptions are not given.

The receiving unit 201 further receives information on first day of use which is input by the owner of the appliance 110 and which is usable for the warranty expiration date determining unit 204 to determine the first day of use of the appliance 110. More specifically, the receiving unit 201 further receives information on the first day of use input by the user (owner).

The transmitting unit 908 transmits, to the user (owner) of the appliance 110, notification prompting the user to input the first day of use which is usable by the warranty expiration date determining unit 204 to determine the first day of use.

The determining unit 907 determines whether or not the usage period estimated by the usage period estimating unit 203 exceeds a predetermined threshold value which indicates that the usage period estimated by the usage period estimating unit 203 falls within the usage period which is usable by the warranty expiration date determining unit 204 to determine the first day of use. When the determining unit 907 determines that the usage period estimated by the usage period estimating unit 203 exceeds the predetermined threshold, the determining unit 907 causes the transmitting unit 908 to transmit the notification.

More specifically, the determining unit 907 determines whether or not the usage period estimated by the usage period estimating unit 203 exceeds a predetermined threshold. When the estimated usage period exceeds the predetermined threshold, the determining unit 907 causes the transmitting unit 908 to transmit the notification prompting the user to input the first day of use of the appliance 110. The threshold here is a value set in advance by, for example, a manufacture or a dealer. The threshold is set to the value that the error of the usage period estimated by the usage period estimating unit 203 is considered to be not accepted by the user.

When the determining unit 907 determines that the usage period estimated by the usage period estimating unit 203 does not exceed the predetermined threshold, the warranty expiration date determining unit 204 determines, as the warranty starting date, the registration date of the appliance 110 on which the user (owner) of the appliance 110 registered the owner information and the appliance information into the information database 206. More specifically, when the determining unit 907 determines that the usage period estimated by the usage period estimating unit 203 does not exceed the predetermined threshold, the warranty expiration date determining unit 204 determines, as the warranty starting date, the date on which the appliance 110 is registered in the information database 206.

On the other hand, when the determining unit 907 determines that the usage period estimated by the usage period estimating unit 203 exceeds the predetermined threshold, the warranty expiration date determining unit 204 determines, as the warranty starting date, the first day of use included in the information input by the user (owner) of the appliance 110. More specifically, when the determining unit 907 determines that the usage period estimated by the usage period estimating unit 203 exceeds the predetermined threshold, the warranty expiration date determining unit 204 prompts the user to manually input the first day of use of the appliance 110 and determines the manually input first day of use, as the warranty starting date.

For example, in a case where the threshold is set to five days and the usage period estimated by the usage period estimating unit 203 is 10 days, the usage period exceeds the threshold; and thus, the first day of use input by the user is determined to be the warranty starting date. On the other hand, in a case where the usage period estimated by the usage period estimating unit 203 is 3 days, the usage period does not exceed the threshold; and thus, the date of registration of the appliance 110 into the information database 206 is determined to be the warranty starting date.

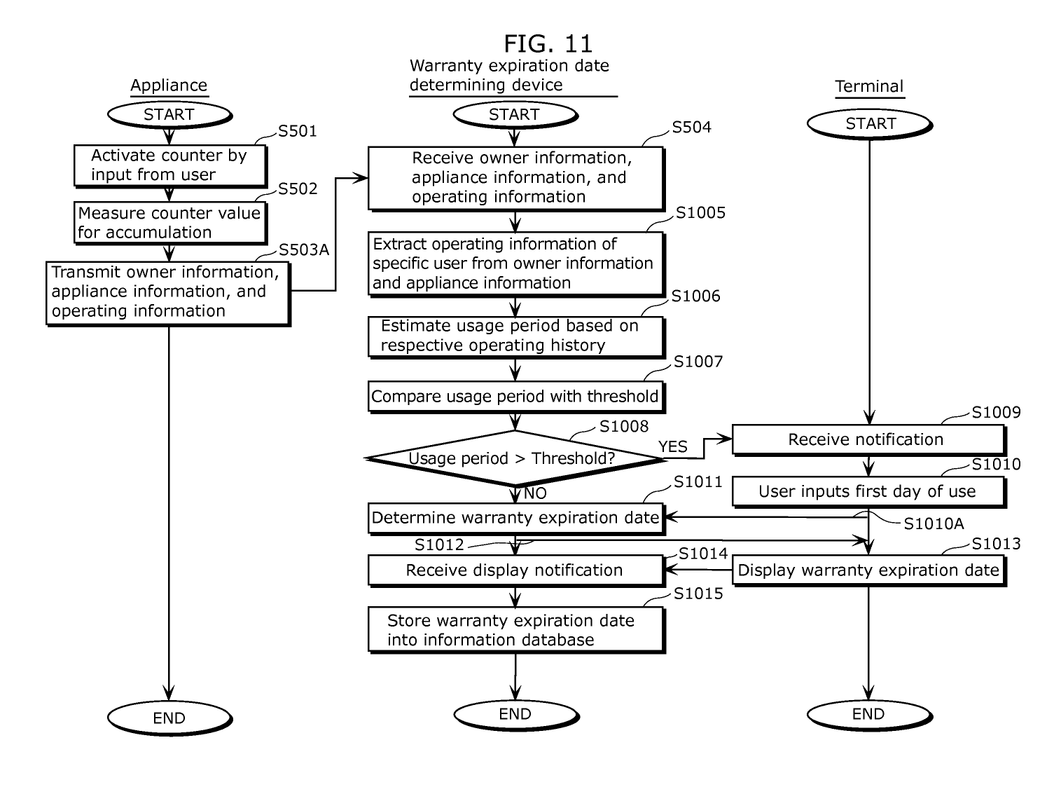

FIG. 11 is a sequence diagram of operations of the warranty expiration date determining device 100A, the appliance 110, and the terminal 830 according to Embodiment 2. The processing in FIG. 11 same as those in FIG. 6 according to Embodiment 1 are identified with the same step numbers, and duplicated descriptions are not given. In FIG. 11, S1005 corresponds to S505 to S507 in FIG. 6.

The processing in S503A is different from that in S503 in that information is transmitted to the warranty expiration date determining device 100A.

The receiving unit 201 of the warranty expiration date determining device 100A receives, from the appliance 110, owner information, appliance information, and operating information (S504). After that, the obtaining unit 202 obtains operating information of a specific user from the information database 206 (S1005).

Next, the usage period estimating unit 203 of the warranty expiration date determining device 100A estimates the usage period of the appliance 110, using the operating information obtained from the appliance 110 and the operating information of the specific user obtained from the information database 206 (S1006).

Next, in the warranty expiration date determining device 100A, the determining unit 907 compares the usage period estimated by the usage period estimating unit 203 with a predetermined threshold (S1007).

When the estimated usage period is greater than the predetermined threshold (Yes in S1008), the determining unit 907 transmits, to the terminal 830, notification prompting the user to input the first day of use.

The terminal 830 receives the notification (S1009). The user inputs, via the terminal 830, information on the first day of use (S1010). Then, the terminal 830 transmits the input first day of use to the warranty expiration date determining device 100 (S1010A).

Next, in the warranty expiration date determining device 100A, the warranty expiration date determining unit 204 determines the expiration date based on the determination result of the determining unit 907 (S1011).

More specifically, when the determining unit 907 determines in S1008 that the usage period estimated by the usage period estimating unit 203 does not exceed a predetermined threshold (No in S1008), the warranty expiration date determining unit 204 determines the expiration date, with the registration date of the appliance 110 into the information database 206 as the warranty starting date.

On the other hand, when the determining unit 907 determines that the usage period estimated by the usage period estimating unit 203 exceeds the predetermined threshold (Yes in S1008), the warranty expiration date determining unit 204 determines the warranty expiration date, with the first day of use input by the user as the warranty starting date.

The warranty expiration date determining unit 204 then transmits the determined warranty expiration date to the terminal 830 (S1012).

Upon receipt of information on the warranty expiration date from the warranty expiration date determining device 100A, the terminal 830 displays the warranty expiration date (S1013). The terminal 830 transmits, to the warranty expiration date determining device 100A, display notification indicating that the warranty expiration date information was displayed (S1013).

Upon receipt of the display notification (S1014), the warranty expiration date determining unit 204 stores the determined warranty expiration date into the appliance information of the information database 206 in association with the appliance ID of the appliance 110 (S1015).

As described, in Embodiment 2, it is determined whether or not the usage period estimated by the usage period estimating unit 203 exceeds a predetermined threshold. When the predetermined threshold is greater than or equal to the estimated usage period, the registration date of the appliance 110 into the information database 206 is determined as the warranty starting date. On the other hand, when the predetermined threshold is smaller than the estimated usage period, the user is prompted to input the first day of use, and the first day of use input by the user is determined as the warranty starting date.

In this way, even when the estimated first day of use of the appliance 110 is prior to the date on which the user actually started to use the appliance 110, the warranty expiration date of the appliance 110 can be properly set.

As described in Variation of Embodiment 1, the information database 206 may be provided externally to the warranty expiration date determining device 100A.

According to the present disclosure, it is possible to achieve a warranty expiration date determining device and a warranty expiration date determining method, which can automatically determine the warranty starting date of appliances.

More specifically, according to the warranty expiration date determining device and the warranty expiration date determining method according to the present disclosure, the first day of use of an appliance for which warranty expiration date is to be calculated is estimated using operating information of the appliance and the operating information of a specific user registered in the database. Accordingly, even when the appliance for which the warranty expiration date is to be calculated does not include a clock function, the warranty starting date of the appliance can be determined, thereby determining the warranty expiration date of the appliance.

It has been described in Embodiments 1 and 2 that the appliance 110 does not include a clock; however, of course, each embodiment disclosed herein is effective also in a case where a clock is included.

The warranty expiration date determining device according to the present disclosure has been described based on embodiments; however, the present disclosure is not limited to these embodiments.

Those skilled in the art will readily appreciate that various modifications may be made in these exemplary embodiments without materially departing from the principles and spirit of the inventive concept, the scope of which is defined in the appended Claims and their equivalents.

For example, all or part of the constituent elements included in the warranty expiration date determining device 100 or the warranty expiration date determining device 100A may be configured by a hardware. All or part of the constituent elements included in the memory management unit may be a module of a program executed by a central processing unit or the like.

All or part of the constituent elements in the warranty expiration date determining device 100 or the warranty expiration date determining device 100A may be configured from a single large scale integration (LSI). The System LSI is a super-multi-function LSI manufactured by integrating constituent units on one chip, and is specifically a computer system configured by including a microprocessor, a read only memory (ROM), a random access memory (RAM), and so on.

For example, the warranty expiration date determining device 100 or the warranty expiration date determining device 100A may be configured from a single system LSI (integrated circuit). In other words, the warranty expiration date determining device 100 or the warranty expiration date determining device 100A may be an integrated circuit.

Furthermore, the present disclosure may be implemented as a warranty expiration date determining method including, as steps, the operations of the characteristic units included in the warranty expiration date determining device 100 or the warranty expiration date determining device 100A. Furthermore, the present disclosure may be implemented as a program causing a computer to execute each step included in the warranty expiration date determining method. Furthermore, the present disclosure may be implemented as a computer-readable recording medium storing such a program. Furthermore, such a program may be distributed via a transmission medium such as the Internet.

All the numerical values used in each embodiment are an example for specifically describing the present disclosure. In other words, the present disclosure is not limited to the numerical values used in each embodiment.

Furthermore, the structure of the warranty expiration date determining device 100 is an example for specifically describing the present disclosure. In other words, the warranty expiration date determining device 100 does not have to include all of the constituent elements shown in FIG. 2. More specifically, the warranty expiration date determining device 100 according to the present disclosure may include only minimum elements for achieving the advantageous effects of the present disclosure. For example, if the usage period estimating unit 203 also performs processing that is performed by the obtaining unit 202, the warranty expiration date determining device 100 does not have to include the obtaining unit 202. The same applies to the warranty expiration date determining device 100A.

Furthermore, the warranty expiration date determining method according to the present disclosure corresponds to any one of processing in FIGS. 6, 8, and 11 that are performed by the warranty expiration date determining device 100 or the warranty expiration date determining device 100A. The warranty expiration date determining method according to the present disclosure does not always have to include all of the steps corresponding to FIGS. 6, 8, and 11. In other words, it is sufficient that the warranty expiration date determining method according to the present disclosure only includes minimum steps for achieving the advantageous effects of the present disclosure.

Furthermore, the processing order of each step in the warranty expiration date determining method is an example for specifically describing the present disclosure, and of course, the processing order may be different. Part of steps in the warranty expiration date determining method and other steps may be executed independently in parallel.

The herein disclosed embodiments are to be considered descriptive and illustrative only, and the appended Claims are of a scope intended to cover and encompass not only the particular embodiment(s) disclosed, but also equivalent structures, methods, and/or uses.

### INDUSTRIAL APPLICABILITY

The present disclosure is useful in a system for estimating the usage period of an appliance, and, in particular, is useful for an appliance connected to a network.

### REFERENCE SIGNS LIST

1, 2, 3 Warranty expiration date system
100, 100A Warranty expiration date determining device
110, 110A, 210 Appliance
120 Network
130 Relay device
201 Receiving unit
202 Obtaining unit
203 Usage period estimating unit
204 Warranty expiration date determining unit
205 Time information obtaining unit
206 Information database
301 Owner information
302 Appliance information
303 Operating information
401 Power source unit
402 User input unit
403 Control unit
404 Counter
405, 405A Accumulating unit
406 Appliance information managing unit
407, 407A, 908 Transmitting unit
408 Usage history generating unit
830 Terminal
831 Display unit
832 Input unit
907 Determining unit

1-16. (canceled)

17. A warranty expiration date determining device comprising:
a receiving unit configured to receive first owner information, first appliance information, and first operating information of a first appliance for which a warranty expiration date is to be calculated;
an obtaining unit configured to obtain second operating information from an information database, based on the first owner information and the first appliance information received by the receiving unit, the information database being a database in which at least second owner information, second appliance information, and the second operating information of each of one or more second appliances different from the first appliance are registered in association with an owner of the second appliance, and the obtained second operating information being associated with the owner of second appliance;
a usage period estimating unit configured to estimate a usage period of the first appliance based on the second operating information obtained by the obtaining unit and the first operating information received by the receiving unit; and
a warranty expiration date determining unit configured to determine the warranty expiration date of the first appliance based on information on a current date and the usage period estimated by the usage period estimating unit.

18. The warranty expiration date determining device according to claim 17,
wherein the first operating information includes usage frequency of the first appliance and an average usage length which is an average length of usage of the first appliance in a predetermined period.

19. The warranty expiration date determining device according to claim 17, further comprising:
a determining unit configured to determine whether or not the usage period estimated by the usage period estimating unit exceeds a predetermined threshold,
wherein the warranty expiration date determining unit is configured to determine the warranty expiration date of the first appliance based on a result of the determination by the determining unit.

20. The warranty expiration date determining device according to claim 19, further comprising:
a transmitting unit configured to transmit, to an owner of the first appliance, a notification prompting the owner of the first appliance to input a first day of use of the first appliance,
wherein, when the determining unit determines that the usage period estimated by the usage period estimating unit exceeds the threshold, the determining unit is configured to cause the transmitting unit to transmit the notification,
the receiving unit is configured to receive information on the first day of use input by the owner of the first appliance, and
the warranty expiration date determining unit is configured to determine the warranty expiration date of the first appliance based on the first day of use included in the information input by the owner of the first appliance.

21. The warranty expiration date determining device according to claim 19,
wherein, when the determining unit determines that the usage period estimated by the usage period estimating unit does not exceed the threshold, the warranty expiration date determining unit is configured to determine the warranty expiration date of the first appliance based on a date on which the owner of the first appliance registered the first owner information and the first appliance information into the information database.

22. The warranty expiration date determining device according to claim 17,
wherein the obtaining unit is configured to
obtain the second operating information associated with the owner of the second appliance, from the information database and using the first owner information and the first appliance information received by the receiving unit, the owner being associated with the second owner information and the second appliance information that are similar to the first owner information and the first appliance information.

23. The warranty expiration date determining device according to claim 17,
wherein the obtaining unit is configured to obtain the second operating information associated with the owner of the second appliance, from the information database and using the first owner information and the first appliance information received by the receiving unit, the owner being associated with the same owner information as the first owner information and associated with the second appliance information similar to the first appliance information.

24. The warranty expiration date determining device according to claim 22,
wherein the first owner information includes at least one of a name, an age, a sex, a family structure, and an occupation of the owner of the first appliance, and the second owner information includes at least one of a name, an age, a sex, a family structure, and an occupation of the owner of the second appliance, and
the first appliance information indicates a type of the first appliance, and the second appliance information indicates a type of the second appliance.

25. The warranty expiration date determining device according to claim 17,
wherein the warranty expiration date determining unit is configured to register the determined warranty expiration date of the first appliance into the information database, in association with the first owner information and the first appliance information.

26. The warranty expiration date determining device according to claim 17, comprising
the information database.

27. A warranty expiration date determining method for use in a warranty expiration date determining device which determines a warranty expiration date of a first appliance, the warranty expiration date determining method comprising:
receiving first owner information, first appliance information, and first operating information of the first appliance;
obtaining second operating information from an information database, based on the first owner information and the first appliance information received in the receiving, the information database being a database in which at least second owner information, second appliance information, and the second operating information of each of one or more second appliances are registered in association with an owner of the second appliance, and the obtained second operating information being associated with the owner of second appliance;
estimating a usage period of the first appliance based on the first operating information received in the receiving and the second operating information obtained in the obtaining of the second operating information; and
determining the warranty expiration date of the first appliance based on information on a current date and the usage period estimated in the estimating.

28. A non-transitory computer-readable recording medium having recorded thereon a program for determining a warranty expiration date of a first appliance, the program causing a computer to execute:
receiving first owner information, first appliance information, and first operating information of the first appliance;
obtaining second operating information from an information database, based on the first owner information and the first appliance information received in the receiving, the information database being a database in which at least second owner information, second appliance information, and the second operating information of a plurality of second appliances are registered in association with an owner of the second appliance, and the obtained second operating information being associated with the owner of second appliance;
estimating a usage period of the first appliance based on the first operating information received in the receiving and the second operating information obtained in the obtaining of the second operating information; and
determining the warranty expiration date of the first appliance based on information on a current date and the usage period estimated in the estimating.

29. An appliance for which a warranty expiration date is to be calculated, the appliance comprising:
a counter which operates according to a usage of the appliance and measures a usage length or a usage count of the appliance;
an accumulating unit configured to accumulate a value measured by the counter;
an appliance information managing unit configured to manage appliance information of the appliance;
a receiving unit configured to receive notification from a warranty expiration date determining device which calculates the warranty expiration date of the appliance, the notification prompting a user of the appliance to input a first day of use of the appliance;
an input unit configured to receive the input of the first day of use of the appliance from the user; and
a transmitting unit configured to transmit, to the warranty expiration date determining device, operating information of the appliance including the value of the counter accumulated in the accumulating unit and the first day of use of the appliance received by the input unit.

30. The appliance according to claim 29, further comprising
an operating history generating unit configured to generate a total usage length or a total usage count based on the value measured by the counter,
wherein the transmitting unit is configured to transmit, to the warranty expiration date determining device, the operating information of the appliance along with the appliance information, the operating information including the total usage length or the total usage count generated by the operating history generating unit.

31. The appliance according to claim 29,
wherein the transmitting unit is configured to transmit the value accumulated in the accumulating unit to a relay device to cause the relay device (i) to generate a total usage length or a total usage count based on the value measured by the counter, and (ii) to transmit, to the warranty expiration date determining device, the operating information of the appliance along with owner information and the appliance information, the operating information including the generated total usage length or the total usage count, and the relay device holding at least the owner information and the appliance information of the appliance and being capable of transmitting data to the warranty expiration date determining device.

32. A warranty expiration date determining system comprising:
a first appliance for which a warranty expiration date is to be calculated; and
a warranty expiration date determining device which calculates the warranty expiration date of the first appliance,
wherein the first appliance includes:
an input unit configured to receive an operation of a user;
a counter which measures a usage length or a usage count of the first appliance;
a control unit configured to activate the first appliance and the counter based on the operation received by the input unit;
an accumulating unit configured to accumulate the value measured by the counter;
an appliance information managing unit configured to manage first appliance information of the first appliance; and
a transmitting unit configured to transmit, to the warranty expiration date determining device, first operating information of the first appliance including the value of the counter accumulated in the accumulating unit, along with at least the first appliance information, and
the warranty expiration date determining device includes:
a receiving unit configured to receive first owner information, the first appliance information, and the first operating information of the first appliance;
an obtaining unit configured to obtain second operating information, from an information database, based on the first owner information and the first appliance information received by the receiving unit, the information database being a database in which at least second owner information, second appliance information, and the second operating information of each of one or more second appliances different from the first appliance are registered in association with an owner of the second appliance, and the obtained second operating information being associated with the owner of second appliance;
a usage period estimating unit configured to estimate a usage period of the first appliance based on the second operating information obtained by the obtaining unit and the first operating information received by the receiving unit; and
a warranty expiration date determining unit configured to determine the warranty expiration date of the first appliance based on information on a current date and the usage period estimated by the usage period estimating unit.
